(19) United States
(12) Patent Application Publication
(10) Pub. No.: US 2005/0217364 A1
(43) Pub. Date: Oct. 6, 2005

(54) Air valve housing with tire pressure indicator

(76) Inventor: Brandon Maldonado, Yorba Linda, CA (US)

Correspondence Address: GENE SCOTT; PATENT LAW & VENTURE GROUP, 3140 RED HILL AVENUE, SUITE 150, COSTA MESA, CA, 92626-3440, US

(21) Appl. No.: 10/817,219

(22) Filed: Apr. 1, 2004

(51) Int. Cl. G01M 17/02

(52) U.S. Cl. 73/146.8

(57) ABSTRACT

An inner cylinder has a reduced diameter portion and a proximally disposed transverse aperture. An outer cylinder has a distally disposed transverse hole. The inner and outer cylinders are coaxially disposed and sealingly engaged distally, thereby forming a cylindrical space between them. A cylindrical piston within the cylindrical space is slidably urged proximally by a coil spring. A cylindrical seal separates the space between a higher pressure proximal zone and a lower pressure distal zone, the seal moving with the piston. A mounting cylinder is sealingly engaged with the outer cylinder and terminates proximally with an internal thread for engaging a typical valve stem or a wheel mount for mounting the apparatus on an automotive wheel in place of a typical valve stem.

### INCORPORATION BY REFERENCE

Applicant(s) hereby incorporate herein by reference, any and all U.S. patents, U.S. patent applications, and other documents and printed matter cited or referred to in this application.

### BACKGROUND OF THE INVENTION

1. Field of the Invention

This invention relates generally to air pressure level indicators for tires and the like, and more particularly to such an indicator capable of distinguishing between adequate, marginal and under inflated conditions in a tire and which has simple and rugged construction.

2. Description of Related Art

The following art defines the present state of this field:

Maldonado et al, U.S. Pat. No. 6,293,297 teaches a tire pressure indicator mounted onto the fill stem of a tire and provides a window for indicating if the tire has adequate pressure or not. The indicator show adequate, marginal and underinflated conditions by color bands opposite the window. The pressure indicator may be permanently mounted onto the tire and used to fill the tire and maintain pressure in the tire. As the tire is filled the indicator moves from one color band to the next until the indicator shows that adequate pressure has been attained whereupon the hose may be disconnected.

Lindsay, U.S. Pat. No. 3,969,936 describes an inflation valve gauge including a tubular stem having an inner end connected to a pressurized chamber such as formed by a tire, and an outer end provided with an inflation valve; die stem being surrounded by a special, helically wound Bourdon type pressure gauge tube, having an axially inner end penetrating a wall of the tubular stem and an outer end having a pointer overlying an axially directed scale plate; the gauge tube being surrounded by a sleeve which supports the scale plate and is joined to the stem axially inward from the gauge tube; the convolutions of the gauge tube being disposed in close proximity, the confronting wall surfaces of the stem and sleeve being in close proximity to the convolutions of the gauge tube to restrain the gauge tube against extreme mechanical forces tending to damage the gauge tube.

Heyns, U.S. Pat. No. 5,535,623 describes a tire pressure indicator which has a screw-threaded socket for long term but removable association with a tire valve. The body of the indicator houses a movable operator member; actuator member; and resilient member located between the operator member and actuator member. The arrangement is such that the actuator member is held in a “rest” position by the resilient means which is compressed when the actuator member is moved to a “test” position. The degree of compression and resilience of the resilient means are arranged such that the air release pin of the tire valve is depressed only in the event of air pressure in the tire being inadequate to counter the force exerted thereon through the resilient means. The sound of the air escaping in the “test” position is indicative of a low tire pressure.

Mottram, U.S. Pat. No. 3,906,988 describes a combined valve and wheel rim gauge for indicating visually whether the air pressure within the tire is adequate for safe operation. The device includes a flexible diaphragm which controls the movement of an indicating sleeve under varying conditions of internal air pressure to provide a continuous reading of under inflation, proper inflation and over inflation.

Poster, U.S. Pat. No. 1,807,752 describes an automobile tire pressure gauge or indicator, comprising a casing closed at its outer end and having sight openings intermediate its ends. The gauge has a base portion connected to the inner end of the casing. The base portion has an inwardly extending threaded part adapted to detachably engage with a valve stem. Me base portion has an opening therethrough registering with the valve stem and having a bar adapted to engage the pin of the valve for maintaining the same open when the base portion is in position. A transparent cylinder mounted in the casing and having an opening through its inner end receives air from the base potion. A piston slidably mounted in the transparent cylinder which has surface portions of different colors is adapted to register as the against the outer end of the piston urges the latter inwardly against the air pressure.

Stuart, U.S. Pat. No. 1,594,386 describes a removable locked indicating valve stem comprises in combination an expandable air chamber in direct connection with the air in a pneumatic tire and in part a section of valve stem with metallic walls and in part a section of valve stem lined with a flexible rubber member actuated by a pressure spring opposed to the compressed air, an indicating member on the chamber's movable end and actuated by the spring indicating the variance of air pressure in the air chamber, a base member connected in juxtaposition with the pneumatic tire, a shut-off check valve in the base member, a removable tubular member thread-ably secured to said base member, and enlarged flange on the removable tubular member at its connecting end adapted to prevent it passing through the valve stem hole in the metal rim of the tire wheel from the tire side, and indicating scale on said tubular member in juxtaposition with said indicating member and adapted for indicating the pounds pressure, a sliding tubular member loosely mounted within the outer part of the removable tubular member and adapted to be forced across the opening in the metal-walled part of the air chamber by the pressure of air from the supply tube so as to conduct the supply of air to the inlet connecting with the pneumatic tire.

Sweetland, U.S. Pat. No. 1,539,030 describes a pressure indicating device comprising a casing, a sleeve movable within said casing and provided with graduations, a tube having means embedded therein for preventing lateral while permitting longitudinal extension of the tube, and a coiled spring located in the annular space between the sleeve and the tube and arranged to resist the longitudinal extension of the latter.

Gilbough, U.S. Pat. No. 1,309,517 describes in combination with a vehicle wheel and an inflatable tire thereon, a movable pressure operated registering means in operative connection with the tire, and an arm connected to the wheel rim to be moved by movement of said means to project beyond the wheel and strike a stationary part of the vehicle when the tire is not properly inflated.

Harrison et al., U.S. Pat. No. 1,214,714 describes a tire pressure gauge, comprising the combination with the rim of a wheel and the inner tube of a tire, of a bushing tube secured to the rim and passing through the aperture in the same, a tire valve member endwise movable in the bushing tube, means for clamping the inner end of the member to the inner tube, the tire valve member adapted to be pressed outwardly by the inflation of the inner tube, resilient means opposing the outward movement and a tire inflating valve within the tire valve member, the tire valve member having a passage through the same controlled by the tire inflating valve whereby the inner tube of the tire may be inflated through the tire valve member.

Bromberg, U.S. Pat. No. 1,176,338 describes combined tire valve and pressure gauge, the combination of a base piece, an intermediate piece mounted therein provided with a valve seat at its lower end and a central hole longitudinally therethrough serving as an air conductor and with a chamber disposed in one side thereof with a POM the port and central hole terminating in the valve seat, and air valve covering the lower end of the central hole and the port in the valve seat, a plunger reciprocally mounted in the chamber, yielding means engaging with the plunger and means for indicating the pressure on the plunger in connection with the plunger thereon provided with a curved valve seat with ports leading directly therefrom to the inner surface of said cylindrical piece, a valve mounted in the curved seat, and air conducting tube secured in the cylindrical piece, a valve stem mounted in the tube extending through the outer surface of the cylindrical piece, means for holding the valve seated, a plunger reciprocally mounted in the cylindrical piece, a pressure indicating means in connection therewith and spring for regulating the movement of said plunger.

Hathaway, U.S. Pat. No. 1,1079,704 describes a tire valve barrel having eccentric and parallel air and gage tube bores, the lower end of the latter bore having a primary and an eccentric secondary counter-bore and the upper end of the latter bore terminating short of the tip of the barrel, a mercury tube fitting in the bore and having its outer end closed and seated against the upper end of the bore, the lower end of the tube being open and entering the primary counter-bore, a packing ring in the counter-bore around the end of the tube, a diaphragm having its edges thickened and seated against the shoulder formed by the secondary counter-bore so as to space the diaphragm from the shoulder, and a binding ring screw-threaded into the secondary counter-bore and bearing against the thickened edge of the diaphragm to retain the diaphragm in position, a portion o the valve being cut away to expose the tube and bearing graduations.

Our prior art search with abstracts described above teaches the use of a moving indicator to monitor tire air pressure, but does not teach a simple device with moving cylindrical piston mounted between cylindrical casings engaged at one end with dual annular and axially spaced apart surfaces so as to make a very inexpensive assembly. The present invention fulfills these needs and provides further related advantages as described in the following summary.

### SUMMARY OF THE INVENTION

The present invention teaches certain benefits in construction and use which give rise to the objectives described below.

An inner cylinder has a reduced diameter portion and a proximally disposed transverse aperture. An outer cylinder has a distally disposed transverse hole. The inner and outer cylinders are coaxially disposed and sealingly engaged distally, thereby forming a cylindrical space between them. A cylindrical piston within the cylindrical space is slidably urged proximally by a coil spring. A cylindrical seal separates the space between a higher pressure proximal zone and a lower pressure distal zone, the seal moving with the piston. A mounting cylinder is sealingly engaged with the outer cylinder and terminates proximally with an internal thread for engaging a typical valve stem or a wheel mount for mounting the apparatus on an automotive wheel in place of a typical valve stem.

A primary objective of the present invention is to provide a pressure indicator having advantages not taught by the prior art.

A further objective is to provide an indicator that is able to display tire air pressure status depending upon tire pressure changes in a tire.

A still further objective is to provide such an indicator that is able to be used for admitting air into a tire.

A yet further objective is to provide such an indicator that is able to be mounted on a tire wheel in place of a typical air valve stem.

Other features and advantages of the present invention will become apparent from the following more detailed description, taken in conjunction with the accompanying drawings, which illustrate, by way of c2iample, the principles of the invention.

### BRIEF DESCRIPTION OF THE DRAWING

The accompanying drawings illustrate the present invention. In such drawings:

FIG. 1 is an exploded perspective view of the preferred embodiment of the present invention;

FIG. 2 is similar to FIG. 1 showing the invention as assembled; and

FIGS. 3 and 4 are cross-sectional views taken along cutting plane line 3-3 and 4-4 respectively.

### DETAILED DESCRIPTION OF THE INVENTION

The above described drawing figures illustrate the invention in at least one of its preferred embodiments, which is further defined in detail in the following description. Those having ordinary skill in the art may be able to make alterations and modifications in the present invention without departing from its spirit and scope. Therefore, it must be understood that the illustrated embodiments have been set forth only for the purposes of example and that they should not be taken as limiting the invention as defined in the following.

The present invention is a tire air fill and indicator of acceptable pressure level. The apparatus has opposing proximal 10 and distal 20 ends and throughout this description the use of the words proximal, medial and distal, or related words, shall refer to the portions of the several parts of this invention that are related to this sense of distal at one end and proximal at the opposing end, always in relationship to the overall invention.

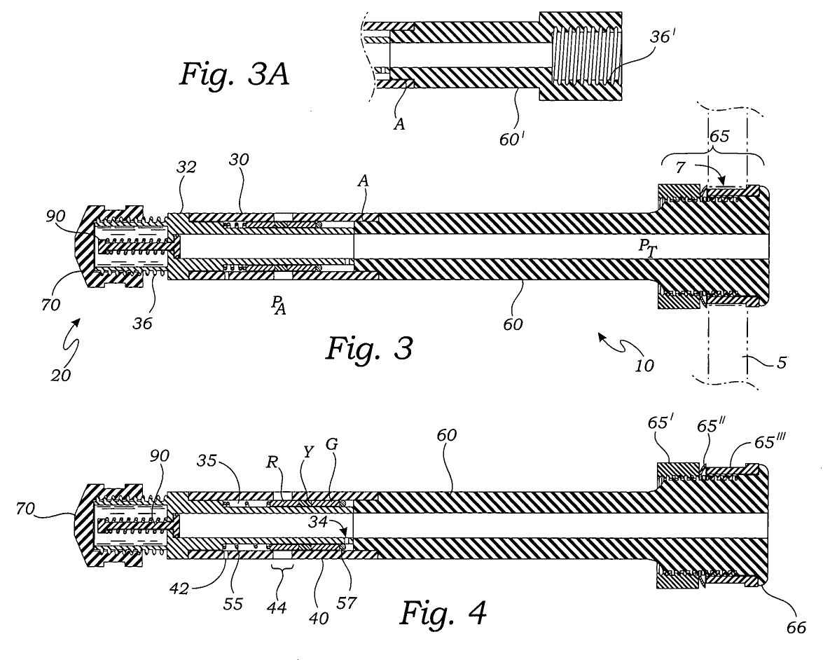

The parts of this invention are made of high strength engineering materials such as metal, glass or plastics, unless otherwise specified. Referring now to the several figurers, an inner cylinder 30 has an outwardly peripheral flange 32 at a distally disposed end thereof and a reduced diameter portion 31 at a medial portion and a proximally disposed end. The inner cylinder 30 further has at least one proximally disposed transverse aperture 34 for admitting air flow from the interior of the inner cylinder 30 to its exterior. An outer cylinder 40 provides at least one distally disposed transverse hole 42 for admitting air into a cylindrical space 35 between the inner and the outer cylinders, 30, 40. The inner 30 and outer 40 cylinders are coaxially disposed with the outer cylinder 40 press fitted or otherwise engaged distally onto the inner cylinder 30, thereby forming the cylindrical space 35 between them due to the reduced diameter portion 31. The outer cylinder 40 is distally disposed in contact with the flange 32. A male threaded nipple 36 distally terminates the inner cylinder and preferably incorporates air valve 90 as is well known in the art. Such a nipple may have a cap 70 threaded onto it, as is also well known. A cylindrical piston 50 is slidably positioned within the cylindrical space 35. A coil spring 55 is positioned in the space 35 at a distal end of the piston 50 and urges the piston 50 in the proximal direction. A cylindrical seal 57, such as an o-ring, is positioned proximally to the piston in the space 35 and although able to slide freely in space 35, this o-ring seals space 35 between a high pressure proximal zone on one side of the o-ring, and a lower pressure distal zone on the opposing side of the o-ring. A mounting cylinder 60 is press fitted axially onto the proximal end of the outer cylinder 40 and this connection is critical as it must be an air-tight seal. See letter “A” in FIG. 3. The mounting cylinder 60 terminates proximally with a tire wall mounting means 65 comprising a grommet 65′″ a cupped or convex spring washer 65″ and a rubber grommet 65′. The mounting cylinder 60 terminates proximally with flange 66.

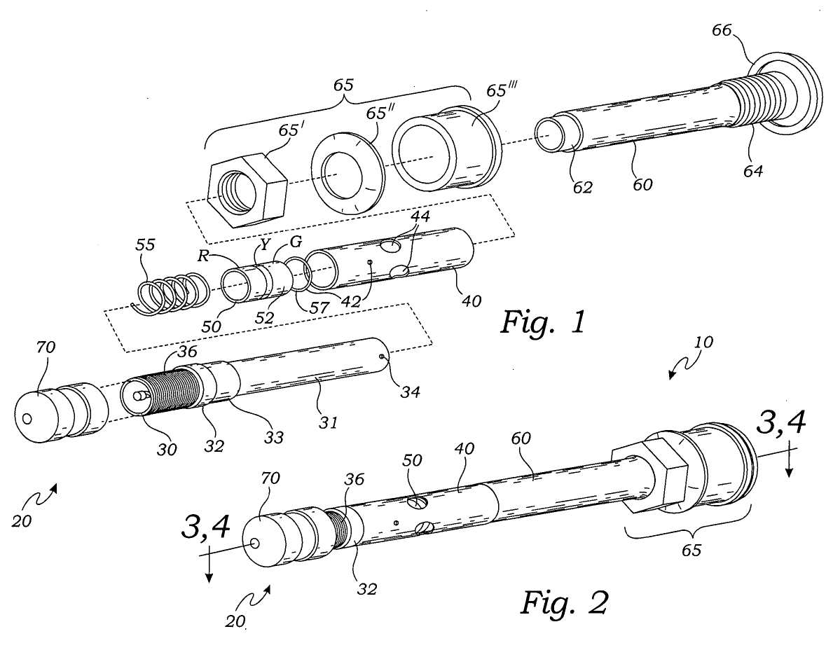

The outer cylinder 40 provides a means for viewing the piston 50, where said piston is able to move axially within the space 35. The viewing means may be by simiple transparency of the outer cylinder 40, assuming that it may be made of a transparent material, or it may be a sealed window 44 in the outer cylinder 40. In the case where window 44 is not sealed, the piston 50 is adapted by its size and position to be restricted from moving to such an extent distally as to expose the seal 54 to window 44 so as to prevent tire pressure from escaping. Preferably, the piston 50 is marked on its outer surface 52 so as to indicate its axial position as viewed through the window 44. Such marking is preferably the colors red, yellow and green shown in FIG. 1 by the letters “R,” “Y,” and “G.” Coloration of the piston 50 may be by anodizing, irriditing, painting or any other common method.

In use, the present invention is mounted onto the wheel 5 (FIG. 3) for an automotive tire using the wheel mounting means 65. This is accomplished by inserting the invention through a mounting hole 7 in the wheel 5 with the concave washer 65″ and mounting nut 65′ removed. Then, with the invention in place in the hole 7, and the rubber grommet 65′″ sealed to the wheel 5; washer 65″ and nut 65′ are tightened against the outside surface of the tire wheel 5. Prior to filling the tire with air, the coil spring 55 is fully extended proximally and the red zone of the piston 50 is visible through window 44. When the tire is filled to specified operating pressure P_{T} as shown in FIG. 3, the interior of the mounting cylinder 60 and the inner cylinder 30 are at pressure P_{T} as is clearly shown in the figures. Transverse aperture 34 admits this tire pressure P_{T} into the proximal end of the space 35 as well. Transverse hole 42 admits atmospheric pressure P_{A} into the distal end of space 35. Piston 50 and seal 57 are able to move freely in space 35 against coil spring 55, so that as tire pressure P_{T} rises the piston 50 moves distally against coil spring 55 causing it to compress, as P_{T} is generally significantly greater then P_{A}. P_{T} is generally in the range of 50 to 70 pounds per square inch (psi), while atmospheric, although somewhat variable depending on climatic conditions, is in the neighborhood of 15 psi. Therefore, coil spring 55 is selected to provide a neutralizing force corresponding to at least 35 psi when the tire is fully inflated and the piston 50 shows its green portion through window 44. Should tire pressure P_{T} drop for any reason, spring 55 forces piston 50 proximally until the yellow portion is visible through window 44 notifying the owner to add air pressure to the tire. When the red portion of the piston 50 is visible it is highly desirable to add air to the tire for fear of tire damage during use or unsafe driving conditions.

In an alternate embodiment shown in FIG. 3A, an alternate mounting cylinder 60′ may be adapted to mount onto a common tire inlet valve (not shown) with female threads 36′.

The words used in this specification to describe the invention and its various embodiments are to be understood not only in the sense of their commonly defined meanings, but to include by special definition in this specification: structure, material or acts beyond the scope of the commonly defined meanings. Thus if an element can be understood in the context of this specification as including more than one meaning, then its use must be understood as being generic to all possible meanings supported by the specification and by the word or words describing the element.

The definitions of the words or elements of this described invention and its various embodiments are, therefore, defined in this specification to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements in the invention and its various embodiments below or that a single element may be substituted for two or more elements in a claim.

Changes from the claimed subject matter as viewed by a person with ordinary skill in the art, now known or later devised, are expressly contemplated as being equivalents within the scope of the invention and its various embodiments. Therefore, obvious substitutions now or later known to one with ordinary skill in the art are defined to be within the scope of the defined elements. The invention and its various embodiments are thus to be understood to include what is specifically illustrated and described above, what is conceptually equivalent, what can be obviously substituted, and also what essentially incorporates the essential idea of the invention.

While the invention has been described with reference to at least one preferred embodiment, it is to be clearly understood by those skilled in the art that the invention is not limited thereto. Rather, the scope of the invention is to be interpreted only in conjunction with the appended claims and it is made clear, here, that the inventor(s) believe that the claimed subject matter is the invention.

1. A tire pressure indicating apparatus with opposing proximal and distal ends comprising: an inner cylinder having a reduced diameter portion and a proximally disposed transverse aperture; an outer cylinder having a distally disposed transverse hole; the inner and outer cylinders coaxially disposed and sealingly engaged distally, thereby forming a cylindrical space therebetween; a cylindrical piston within the cylindrical space slidably urged proximally by a coil spring; a cylindrical seal separating the space between a higher pressure proximal zone and a lower pressure distal zone, the seal moving with the piston, and a mounting cylinder air-tight sealingly engaged with the outer cylinder and terminating proximally with a tire air valve mounting means for mounting the apparatus on a tire air valve.

2. The apparatus of claim 1 wherein the outer cylinder provides a viewing means positioned for observing the piston.

3. The apparatus of claim 2 wherein the piston is marked to indicate a tire pressure condition.

4. The apparatus of claim 1 further comprising a threaded nipple distally terminating the inner cylinder.

5. The apparatus of claim 4 wherein the threaded nipple further comprises an air inlet valve.

6. A tire pressure indicating apparatus with opposing proximal and distal ends comprising: an inner cylinder having a reduced diameter portion and a proximally disposed transverse aperture; an outer cylinder having a distally disposed transverse hole; the inner and outer cylinders coaxially disposed and sealingly engaged distally, thereby forming a cylindrical space therebetween; a cylindrical piston within the cylindrical space slidably urged proximally by a coil spring; a cylindrical seal separating the space between a higher pressure proximal zone and a lower pressure distal zone, the seal movable with the piston; the apparatus terminating proximally with a tire wheel mounting means for mounting the apparatus on a tire wheel.

7. The apparatus of claim 6 wherein the outer cylinder provides a viewing means positioned for observing the piston.

8. The apparatus of claim 7 wherein the piston is marked to indicate a tire pressure condition.

9. The apparatus of claim 6 further comprising a threaded nipple distally terminating the inner cylinder.

10. The apparatus of claim 9 wherein the threaded nipple further comprises an air inlet valve.

11. The apparatus of claim 6 wherein the tire wheel mounting means comprises a grommet, a cupped washer and a compression fastener.
